(19) United States
(12) Patent Application Publication
(10) Pub. No.: US 2023/0233294 A1
(43) Pub. Date: Jul. 27, 2023

(54) TIE-BASE WITH CONICAL SCREW FOR DENTAL IMPLANTS

(71) Applicant: Dan Rosen, Sherman Oaks, CA (US)

(72) Inventor: Dan Rosen, Sherman Oaks, CA (US)

(21) Appl. No.: 17/583,203

(22) Filed: Jan. 25, 2022

(51) Int. Cl. A61C 8/00

(52) U.S. Cl. CPC A61C 8/0068; A61C 8/0074; A61C 8/006; A61C 8/0069

(57) ABSTRACT

A dental implant screw for engaging a tightening apparatus and a dental implant. The dental implant screw extends through a dental tibase and a dental prosthetic. The dental implant screw includes a shaft portion and a head portion, with the shaft portion comprising a shaft having threads disposed at least partially along the length of the shaft and the threads configured to engage the dental implant. The head portion includes a top, a sidewall, and a bottom terminating in the shaft portion. The top includes a bore for receiving the tightening apparatus. The sidewall is conical, having its largest circumference proximal the top, and its smallest circumference proximal the bottom. The sidewall makes complete contact with the tibase when fully inserted into the dental implant.

### BACKGROUND

### Field of the Invention

The present invention generally relates to fixed implant-supported dental prosthetics, including individual tooth, multiple teeth, and full arch prosthetics, supported by one or more dental implants embedded in a patient's bone. More specifically, the present invention relates to a tie-base and conical screw for secure installation of and permanent attachment of restorative dental prosthetics, including, but not limited to individual tooth, multiple teeth, and full arch prosthetics permanently attached to one or more of such dental implants.

### Related Art

Restorative dental implants and prosthetics for persons having lost an appreciable number of natural teeth, whether due to disease, decay or other natural or unnatural processes, have greatly enhanced the quality of life for such persons. These artificial or prosthetic teeth typically comprise a resin or resin-like material in the form of a conventional tooth, an array of teeth, or a full arch of teeth, including in certain instances a prosthetic gum portion into which the prosthetic teeth are embedded.

The process of installing restorative dental prosthetics involves the fixation of a dental implant in the patient's bone, for example, the maxilla, zygoma, and/or jawbone, etc. The dental prosthetic typically includes one or more titanium bases, each known as a “tibase.” The tibases are arranged in the dental prosthetic to align with dental implants installed in the patient. The dental prosthetic, including the tibases, is affixed to the dental implants using a screw. The screw extends through the prosthetic from the inside of the patient's mouth, through the tie base, and into one of the implants, which is anchored in bone.

Tibases currently used in the art have a shelf-like profile on the mouth-facing side of the prosthetic for engagement by the head of the screw. Typical screws are similar to socket cap screws in that they have an undercut between the head and the threaded shaft. The shelf-like profile and undercut are generally at a ninety-degree angle to the direction of the screw and implant. For this reason, there is very little contact between the screw head and the tibase, and flexing pressure on the dental prosthetic can result in gradual loosening of the screw over time and failure of the implant.

Hence, what is needed is a tibase and screw for a dental prosthetic, including but not limited to a full arch dental prosthetic that provides secure, non-loosening fixation to the dental implants of a patient without the limitations of existing techniques.

### SUMMARY

The present apparatus may be characterized as a dental implant screw for engaging a tightening apparatus and a dental implant, with the dental implant screw extending through a dental tibase and a dental prosthetic. The dental implant screw includes a shaft portion and a head portion, with the shaft portion comprising principally a shaft having threads disposed at least partially along the length of the shaft. The threads are configured to engage the dental implant. The head portion includes a top, a sidewall, and a bottom terminating in the shaft portion. The top includes a bore for receiving the tightening apparatus. The sidewall is conical, having its largest circumference proximal the top, and its smallest circumference proximal the bottom, and the sidewall makes complete contact with the tibase when fully inserted into the dental implant.

The shaft portion of the dental implant screw may be only partially threaded. The dental implant screw may also comprise a shoulder portion between the head portion and the shaft portion. In one implementation, the conical sidewall extends to the top of the head portion of the dental implant screw. In another implementation, the bore of the head portion is hexagonal for receiving a hexagonal tightening apparatus. In another implementation, the conical sidewall has an uninterrupted smooth conical surface.

The tibase preferably includes a substantially conical screw bore wall which is complimentary to the conical sidewall of the dental implant screw. In another implementation, the top of the dental implant screw is configured to circumferentially engage a conical screw bore wall of the tibase.

The apparatus may also be characterized as a dental implant screw and tibase apparatus for fastening a dental prosthetic to a dental implant using a tightening apparatus. In this implementation, the dental implant screw and tibase apparatus includes a dental implant screw having a threaded shaft portion and a head portion. The threaded shaft portion is preferably configured to engage the dental implant. The apparatus also includes a tibase apparatus configured for anchoring in the dental prosthetic, and further configured for the dental implant screw to extend through the tibase. The head portion of the dental implant screw includes a top and a sidewall, wherein the sidewall is conical with its largest circumference proximal the top, and its smallest circumference proximal the bottom. The tibase includes a conical screw bore wall configured to engage the sidewall of the head portion, and the sidewall makes complete contact with the screw bore wall of the tibase when fully inserted into the dental implant.

The dental implant screw and tibase apparatus may include a shaft portion of the dental implant screw that is only partially threaded. In another implementation, the dental implant screw further comprises a shoulder portion between the head portion and the shaft portion. Preferably the conical sidewall extends to the top of the head portion of the dental implant screw. The head portion may also include a bore configured to engage the tightening apparatus. In one implementation, the bore may be hexagonal.

The dental implant screw and tibase apparatus may have a conical sidewall that has an uninterrupted smooth conical surface in one implementation, and in such an instance the tibase preferably includes a substantially conical screw bore wall, complimentary to the conical sidewall of the dental implant screw. In another implementation, the top of the dental implant screw may be configured to circumferentially engage a conical screw bore wall of the tibase.

In yet another implementation, the apparatus may be characterized as a dental implant prosthetic apparatus with dental implant screw and tibase for fastening a dental prosthetic to a dental implant using a tightening apparatus. The dental implant prosthetic apparatus includes at least one dental implant screw having a threaded shaft portion and a head portion, the threaded shaft portion configured to engage the dental implant. The apparatus also includes at least one tibase apparatus anchored in the dental prosthetic. Each tibase is configured such that a dental implant screw extends through a tibase when engaging the dental implant through the dental prosthetic.

In this implementation, the head portion of the dental implant screw includes a top and a sidewall, wherein the sidewall is conical with its largest circumference proximal the top, and its smallest circumference proximal the bottom. The tibase in this implementation also includes a conical screw bore wall configured to engage the sidewall of the head portion. The sidewall preferably makes complete contact with the screw bore wall of the tibase when the dental implant screw is fully inserted into the dental implant through the tibase and dental prosthetic.

### BRIEF DESCRIPTION OF THE FIGURES

FIG. 1 illustrates a perspective view of a dental implant screw for use with a tibase and dental implant according to the present disclosure.

FIG. 2 illustrates a cut-away elevation view of the tibase for accommodating the dental implant screw according to the present disclosure.

FIG. 3 illustrates a cut-away elevation view of the dental implant screw installed in the tibase according to the present disclosure.

FIG. 4 illustrates a plan view of a full arch dental prosthetic, including tibases and dental implant screws.

FIG. 5 illustrates a cut away view of the full arch dental prosthetic, with the tibase and dental implant screw installed on a dental implant.

FIG. 6 illustrates a cut away view of a single dental prosthetic, including a tibase and a dental implant screw.

### REFERENCE NUMBERS

10. dental implant screw

12. shaft portion

14. head portion

16. shaft

18. threads

20. bore

22. facets

24. sidewall

26. top

28. bottom

30. tibase

32. semi-cylindrical body

34. outer wall

36. indentations

38. dental prosthetic

40. dental screw bore

42. screw bore wall

44. dental implant bore

46. dental implant bore wall

48. opening

50. shoulder portion

52. gum portion

54. prosthetic teeth

56. dental implant

58. threaded bore

### DESCRIPTION

The following description is presented to enable any person skilled in the art to make and use the apparatus disclosed herein and is provided in the context of a particular application and its requirements. Various modifications to the disclosed implementation will be readily apparent to those skilled in the art, and the general principles defined herein may be applied to other implementations and applications without departing from the spirit and scope of the present disclosure. Importantly, it should be understood that the size or configuration of the components discussed herein may be modified from the manner in which they are depicted and described herein without departing form the spirit and scope of the claimed implementation. Thus, the present disclosure is not limited to the implementation shown but is to be accorded the widest scope consistent with the principles and features disclosed herein.

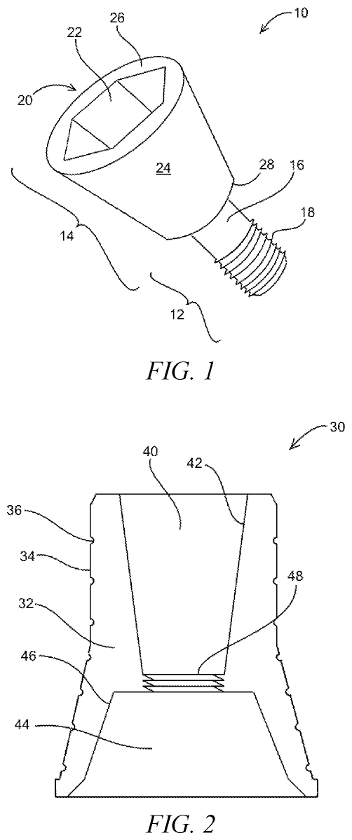

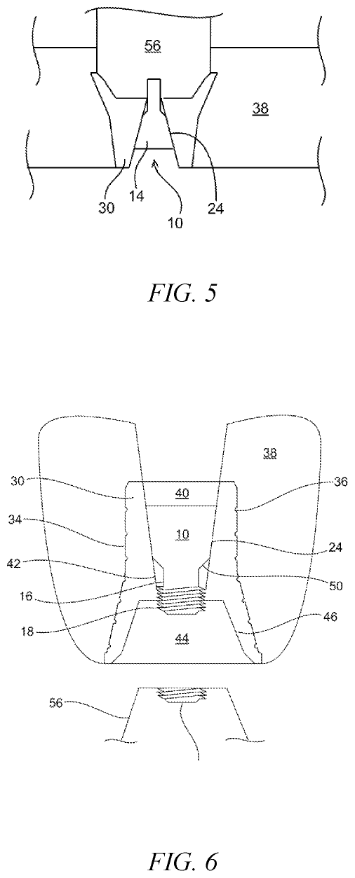

Referring to FIG. 1, a dental implant screw 10 according to one implementation is shown in perspective view. The dental implant screw 10 includes a shaft portion 12 and a head portion 14. The shaft portion 12 includes a shaft 16 and threads 18 along at least a part of its length. The threads 18 are configured to engage a dental implant 56 (FIG. 5). The head portion 14 includes a bore 20 with a series of facets 22 for accommodating a driver (not shown). Although a hexagonal bore 20 with six facets 22 is shown in the illustrated implementation, any shape of bore 20 is contemplated according to preferred construction.

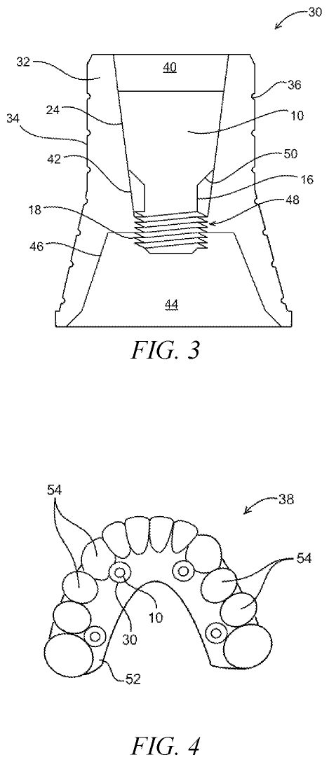

Importantly, the head portion 14 also comprises a uniform conical sidewall 24 extending from the top 26 of the head portion 14 to the bottom 28 of the head portion 14. The conical sidewall 24 preferably has a smooth surface and is configured to engage a tibase 30 (as shown in FIG. 3) such that the entire conical sidewall 24 makes contact with the tibase 30 entirely along its surface. The conical sidewall 22 may be disposed at any preferred angle relative to the shaft portion 12, such that maximum friction is obtained between the implant screw 10 and the tibase 30. It is contemplated that any preferred angle should account for the bore 20 in the head portion 14, such that the bore 20 does not break through the conical sidewall 24 and leaves sufficient material to maintain the integrity of the head portion 14 when tightened against the tibase 30.

Referring to FIG. 2, a cut away view of the tibase 30 is shown in an orientation complimentary to the orientation of the dental implant screw 10 of FIG. 1. In the illustrated implementation, the tibase 30 includes a semi-cylindrical body 32 which is embedded in a dental prosthetic 34 (FIG. 4). In order to anchor the semi-cylindrical body 32 in the dental prosthetic 34, the outer wall 34 of the semi-cylindrical body 32 may include a series of indentations 36 or other similar profile features interrupting the surface of the outer wall 34, to facilitate secure anchoring of the semi-cylindrical body 32 in the dental prosthetic 34.

Still referring to FIG. 2, the tibase 30 includes a dental screw bore 40 for accommodating the dental implant screw 10. The dental screw bore 40 is cylindrical, and complimentary in shape to the dental implant screw 10. The dental screw bore 40 includes a screw bore wall 42 that is substantially smooth, such that it is complimentary to the sidewall 24 of the dental implant screw 10. Preferably, the sidewall 24 of the dental implant screw 10 and the screw bore wall 42 of the tibase 30 dental screw bore 40 make solid contact across the entire surface of the sidewall 24 when the dental implant screw 10 is fully secured in the tibase 30.

The tibase 30 also includes a dental implant bore 44 opposite the dental screw bore 40. The dental implant bore 44 is configured to seat on the dental implant 56, installed in the patient's bone. Thus, in the case of a full arch dental prosthetic 38, as is shown in FIG. 5, a series of tibases 30 will seat on a series of dental implants 56, fastening the dental prosthetic 38 in place. The dental implant bore 44 is preferably complimentary to the dental implant 56 (FIG. 5), such that the dental implant bore wall 46 completely engages the dental implant 56 when installed thereon. The tibase 30 also includes an opening 48 through which the dental implant screw 10 extends. In the illustrated embodiment, the opening 48 is threaded for accommodating the threads of the dental screw 10. It is anticipated that either a threaded or non-threaded opening 48 may be provided according to preference.

FIG. 3 illustrates a cut-away view of the tibase 30 with the dental implant screw 10 inserted therein. In the illustrated view, the tibase 30 includes an opening 48 which is threaded, thereby accommodating the threads 18 of the shaft portion 12 of the dental implant screw 10. In various other implementations, the opening 48 may not be threaded. Although a relatively short shaft portion 12 is shown in the illustration, the shaft portion 12 in other implementations may extend further down, and be of any appropriate length, such that it engages the dental implant 56 such that it more securely anchors in a dental implant 56.

Still referring to FIG. 3, the screw bore wall 42 of the tibase 30 is shown with the sidewall 24 of the head portion 14 of the dental implant screw 10 fully engaging the screw bore wall of the tibase 30. In the illustrated implementation, the dental implant screw 10 has a shoulder portion 50 connecting the sidewall 24 to the shaft 16. In other implementations, the sidewall 24 of the dental implant screw 10 may extend all the way down to the opening 48. In other implementations, the shoulder portion 50 may be larger than as shown in the illustration. In all contemplated implementations, the contact of the dental implant screw 10 sidewall 24 to the screw bore wall 42 of the tibase 30 extends from the top 26 of the dental implant screw 10 at least to the shoulder portion 50 of the dental implant screw 10.

FIG. 4 illustrates an upper full arch dental prosthetic 38 with several of the dental implant screws 10 installed in several tibases 30 anchored in the dental prosthetic 38. The dental prosthetic includes a gum portion 52 and several prosthetic teeth 54, configured to simulate a user's real teeth. The tibases 30 (and dental implant screws 10) are preferably placed as close to the prosthetic teeth 54 as possible, in order to engage dental implants 56 embedded in a patient's bone. Additionally, multiple tibases 30 and dental implant screws 10 (and dental implants 56) are used, such that dental implants 56 can be installed in larger areas of bone as well as smaller bone areas in the patient's mouth, to securely anchor the dental prosthetic 38 in place.

FIG. 5 illustrates a cut-away elevation view of a portion of a dental prosthetic 38 including a tibase 30 and a dental implant screw 10 secured to a dental implant 56. With the tibase 30 secured in the dental prosthetic 38, and the dental implant screw 10 secured through the dental prosthetic 38 and into the dental implant 56, the dental prosthetic 38 is resiliently secured to the dental implant 56. Since the dental implant screw 10 head portion 14 includes a sidewall 24 (complimentary to the screw bore wall 42 of the tibase 30) disposed at an angle oblique to the axis of the shaft 16 of the dental implant screw 10, and in full contact with the tibase 30 screw bore wall 42, it secures the Dental prosthetic 38 securely to the dental implant 56 without the risk of loosening under pressure, such as from chewing or other activities.

FIG. 6 illustrates a cut away elevation view of the dental implant screw 10 installed in a tibase 30 and anchored in a single dental prosthetic 38, and positioned for anchorage in a single dental implant 56. The single dental prosthetic 38 is configured to simulate a single tooth of a user. The tibase 30 (and dental implant screw 10) extend through the prosthetic 38, in order to engage the single dental implant 56 which is embedded in a patient's bone. The single dental implant 56 includes a threaded bore 58 for capturing the threads 18 of the dental implant screw 10, thereby holding the sidewall 24 of the dental implant screw 10 securely against the dental prosthetic 38.

The foregoing descriptions of implementations of the present disclosure have been presented only for purposes of illustration and description. They are not intended to be exhaustive or to limit the present disclosure to the forms disclosed. Accordingly, many modifications and variations will be apparent to practitioners skilled in the art. Additionally, the above disclosure is not intended to limit the present implementations disclosed herein. The scope of the present disclosure is defined by the appended claims.

Although one or more very narrow claims may be presented herein, it should be recognized the scope of this disclosure is much broader than presented by the claims. It is intended that broader claims may be submitted, if appropriate, that claim the benefit of priority from this application.

What is claimed is:

1. A dental implant screw for engaging a tightening apparatus and a dental implant, the dental implant screw extending through a dental tibase and a dental prosthetic, the dental implant screw comprising:
a shaft portion and a head portion;
the shaft portion comprising a shaft and threads disposed at least partially along the length of the shaft, the threads configured to engage the dental implant;
the head portion comprising a top, a sidewall, and a bottom terminating in the shaft portion;
wherein the top includes a bore for receiving the tightening apparatus;
wherein the sidewall is conical with its largest circumference proximal the top, and its smallest circumference proximal the bottom; and
wherein the sidewall makes complete contact with the tibase when fully inserted into the dental implant.

2. The dental implant screw of claim 1 wherein the shaft portion of the dental implant screw is only partially threaded.

3. The dental implant screw of claim 1 wherein the dental implant screw further comprises a shoulder portion between the head portion and the shaft portion.

4. The dental implant screw of claim 1 wherein the conical sidewall extends to the top of the head portion of the dental implant screw.

5. The dental implant screw of claim 1 wherein the bore of the head portion is hexagonal for receiving a hexagonal tightening apparatus.

6. The dental implant screw of claim 1 wherein the conical sidewall has an uninterrupted smooth conical surface.

7. The dental implant screw of claim 1 wherein the tibase includes a substantially conical screw bore wall, complimentary to the conical sidewall of the dental implant screw.

8. The dental implant screw of claim 1, wherein the top of the dental implant screw is configured to circumferentially engage a conical screw bore wall of the tibase.

9. A dental implant screw and tibase apparatus for fastening a dental prosthetic to a dental implant using a tightening apparatus, the dental implant screw and tibase apparatus comprising:
a dental implant screw having a threaded shaft portion and a head portion, the threaded shaft portion configured to engage the dental implant;
a tibase apparatus configured for anchoring in the dental prosthetic, and further configured for the dental implant screw to extend through the tibase;
the head portion of the dental implant screw comprising a top and a sidewall, wherein the sidewall is conical with its largest circumference proximal the top, and its smallest circumference proximal the bottom;
the tibase comprising a conical screw bore wall configured to engage the sidewall of the head portion; and
wherein the sidewall makes complete contact with the screw bore wall of the tibase when fully inserted into the dental implant.

10. The dental implant screw and tibase apparatus of claim 9 wherein the shaft portion of the dental implant screw is only partially threaded.

11. The dental implant screw and tibase apparatus of claim 9 wherein the dental implant screw further comprises a shoulder portion between the head portion and the shaft portion.

12. The dental implant screw and tibase apparatus of claim 9 wherein the conical sidewall extends to the top of the head portion of the dental implant screw.

13. The dental implant screw and tibase apparatus of claim 9 wherein the head portion includes a bore configured to engage the tightening apparatus.

14. The dental implant screw and tibase apparatus of claim 13 wherein the bore is hexagonal.

15. The dental implant screw and tibase apparatus of claim 9 wherein the conical sidewall has an uninterrupted smooth conical surface.

16. The dental implant screw and tibase apparatus of claim 1 wherein the tibase includes a substantially conical screw bore wall, complimentary to the conical sidewall of the dental implant screw.

17. The dental implant screw and tibase apparatus of claim 1, wherein the top of the dental implant screw is configured to circumferentially engage a conical screw bore wall of the tibase.

18. A dental implant prosthetic apparatus with dental implant screw and tibase for fastening a dental prosthetic to a dental implant using a tightening apparatus, the dental implant prosthetic apparatus comprising:
at least one dental implant screw having a threaded shaft portion and a head portion, the threaded shaft portion configured to engage the dental implant;
at least one tibase apparatus anchored in the dental prosthetic, the at least one tibase configured such that the at least one dental implant screw extends through the tibase when engaging the dental implant;
the head portion of the dental implant screw comprising a top and a sidewall, wherein the sidewall is conical with its largest circumference proximal the top, and its smallest circumference proximal the bottom;
the tibase comprising a conical screw bore wall configured to engage the sidewall of the head portion; and
wherein the sidewall makes complete contact with the screw bore wall of the tibase when the dental implant screw is fully inserted into the dental implant through the tibase and dental prosthetic.
